(19) United States
(12) Patent Application Publication
(10) Pub. No.: US 2013/0071705 A1
(43) Pub. Date: Mar. 21, 2013

(54) STRUCTURE, PACKAGING ASSEMBLY, AND COVER FOR MULTI-CELL ARRAY BATTERIES

(71) Applicants: Kristopher John Frutschy, Clifton Park, NY (US); Kanthilatha Bhamidipati, Glenville, NY (US); David T. VanDerwerker, Latham, NY (US); William Waters, Scotia, NY (US); Roger Neil Bull, Derby (GB); Neil Anthony Johnson, Schenectady, NY (US); Owen Scott Quirion, Clifton Park, NY (US); John Raymond Krahn, Schenectady, NY (US); Kashyap Shah, Clifton Park, NY (US); Preston J. McCreary, Larkspur, CO (US); William Schank, Howell, MI (US)

(72) Inventors: Kristopher John Frutschy, Clifton Park, NY (US); Kanthilatha Bhamidipati, Glenville, NY (US); David T. VanDerwerker, Latham, NY (US); William Waters, Scotia, NY (US); Roger Neil Bull, Derby (GB); Neil Anthony Johnson, Schenectady, NY (US); Owen Scott Quirion, Clifton Park, NY (US); John Raymond Krahn, Schenectady, NY (US); Kashyap Shah, Clifton Park, NY (US); Preston J. McCreary, Larkspur, CO (US); William Schank, Howell, MI (US)

(73) Assignee: General Electric Company, Schenectady, NY (US)

(21) Appl. No.: 13/234,638

(22) Filed: Sep. 16, 2011

(51) Int. Cl. H01M 2/10; H01M 10/50

(52) U.S. Cl. 429/62; 429/99; 429/120

(57) ABSTRACT

Manufacturable and serviceable packaging configurations for multi-cell array batteries. A cell alignment structure is provided for positioning and securing an array of electrochemical cells. An inner battery packaging assembly is also provided having the cell alignment structure, a base plate configured to be disposed below the cell alignment structure, and a removable cover configured to fit over the cell alignment structure and attach to the base plate. Furthermore, an outer battery packaging assembly is provided having the inner battery packaging assembly, an outer support plate configured to be disposed below the inner battery packaging assembly, a removable thermal insulating material surrounding the inner battery packaging assembly, and a removable outer battery cover configured to fit over the inner battery packaging and over the surrounding thermal insulating material and attach to the outer support plate.

### BACKGROUND

1. Technical Field

Embodiments of the subject matter disclosed herein relates to batteries. Other embodiments relate to packaging configurations for multi-cell array batteries.

2. Discussion of Art

Multi-celled batteries for storing energy are often packaged in a manner that makes it difficult to manufacture, and later service, the batteries. For example, a vacuum can be pulled between an inner battery box, housing an array of electrochemical cells, and an outer battery housing for thermal insulating purposes. The inner battery box can be sealed inside the outer battery box via welding to maintain the vacuum. As such, the outer battery housing is typically cut open to service elements within the outer battery housing, destroying the outer battery housing and, possibly, other elements as well.

Furthermore, during the manufacturing process, the cells of the array of electrochemical cells are to be accurately positioned with respect to each other. Also, each cell can have an electrically insulating plasma coating applied, or the cells can have pieces of mica material placed between them to electrically insulate the cells from each other. Such positioning and insulating methods can add complexity to the manufacturing process and can add material to the battery, thus increasing the cost of the battery.

It would therefore be desirable to develop a battery with features and characteristics that make the battery more easily manufactured and serviced versus batteries that are currently available.

### BRIEF DESCRIPTION

In an embodiment, a cell alignment structure for an electrochemical device is provided having an array of electrically insulating cell receptacles, each cell receptacle configured to receive and support at least a bottom portion of an electrochemical cell. The array of cell receptacles is configured to provide a determined spacing between adjacent electrochemical cells received, in the cell receptacles.

In an embodiment, an inner battery packaging assembly for an electrochemical device is provided having the cell alignment structure disclosed above herein. The inner battery packaging assembly also provides a base plate configured to be disposed below the cell alignment structure, and a cover configured to fit over the cell alignment structure and removably attach to the base plate.

In an embodiment, an outer battery packaging assembly is provided having the inner battery packaging assembly disclosed above herein and an outer support plate configured to be disposed below the inner battery packaging assembly. The outer battery packaging assembly also provides a thermal insulating material removably surrounding at least a portion of the inner battery packaging assembly. The outer battery packaging assembly further provides an outer battery cover configured to fit over the inner battery packaging assembly, and over the thermal insulating material, and removably attach to the outer support plate.

In an embodiment, an insulated cover for an electrochemical device is provided having an inner battery cover configured to fit over an inner battery assembly. The insulated cover also has an outer battery cover nested over the inner battery cover, where the outer battery cover is attached to a base portion of the inner battery cover along a perimeter portion of the outer battery cover forming a sealed space therebetween. The insulated cover also has a thermal insulating material occupying at least a portion of the sealed space.

In an embodiment, an electrochemical device is provided having an array of electrically insulating cell receptacles. The device also provides a plurality of electrochemical cells, the cells having bodies and top and bottom portions at distal ends of the bodies, wherein the bottom portion of the cells are respectively received in and supported by the cell receptacles. The device further provides a stabilizing section engaging the top portions of the cells, and a base plate positioned under the array of electrically insulating cell receptacles. The device also provides a cover positioned over the stabilizing section and being removably attached to the base plate.

### BRIEF DESCRIPTION OF THE DRAWINGS

Reference is made to the accompanying drawings in which particular embodiments of the invention are illustrated as described in more detail in the description below, in which:

FIG. 1 is an illustration of a first embodiment of a cell alignment structure for a multi-cell electrochemical device;

FIG. 2 is an illustration of an alternative embodiment of a cell alignment structure for a multi-cell electrochemical device;

FIGS. 3A-3B illustrate embodiments of mechanical bias devices that can be integrated into the cell alignment structure of FIG. 1;

FIGS. 4A-4D illustrate several additional embodiments of cell alignment structures (cell trays) for a multi-cell electrochemical device;

FIGS. 5A-5E illustrate several embodiments of cell receptacles of a cell alignment structure mating with a bottom portion of an inserted electrochemical cell;

FIGS. 6A-6B illustrate an embodiment of a multi-cell battery providing built-in cooling channels in the cell alignment structure;

FIGS. 7A-7D illustrate embodiments of modular cell alignment structures configured using a plurality of individual base cell alignment structures;

FIGS. 8A-8B illustrate an embodiment of an inner battery packaging assembly of an electrochemical device;

FIG. 9 is an illustration of an embodiment of the inner battery packaging assembly of FIGS. 8A-8B having ceramic feed-through blocks;

FIG. 10 illustrates an embodiment of a portion of a cooling channel disposed below an exploded view of a portion of a cell alignment structure of an inner battery packaging assembly;

FIG. 11 is an illustration of an embodiment of a lower portion of the inner battery packaging assembly of FIGS. 8A-8B and FIG. 9 having the cover removed to show a cooling channel disposed below the cell alignment structure and above the base plate;

FIG. 12 is an illustration of an embodiment of a stacked configuration of two inner battery packaging assemblies within a larger battery packaging assembly (a battery);

FIG. 13 is an illustration of an embodiment of a battery packaging assembly for an electrochemical device;

FIG. 14 is an exploded view of an embodiment of the battery packaging assembly of FIG. 13;

FIG. 15 is an illustration of a fully assembled view of an embodiment of the battery packaging assembly of FIG. 13 and FIG. 14;

FIGS. 16A-16C illustrate an embodiment of a stacked configuration of several of the battery packaging assemblies (batteries) of FIG. 13 within a rack assembly; and

FIGS. 17. 18A-18B, and 19A-19C illustrate an embodiment of a battery configuration that includes an outer battery cover and an inner battery cover that are integrated into a single cover with thermal insulation therebetween to form a vacuum lid “top hat” configuration.

### DETAILED DESCRIPTION

Embodiments relate to packaging configurations for multi-cell array batteries that are operated at high temperatures (e.g., 300° C. or more). In general, a multi-cell array battery has an inner battery packaging assembly (containing a plurality of electrochemical cells) that resides within a larger (e.g., outer) battery packaging assembly. The inner and outer packaging assemblies are configured such that the assemblies and/or the multi-cell array battery are more easily manufactured and serviced than batteries that are currently available.

With reference to the drawings, like reference numerals designate identical or corresponding parts throughout the several views. However, the inclusion of like elements in different views does not mean a given embodiment necessarily includes such elements or that all embodiments of the invention include such elements.

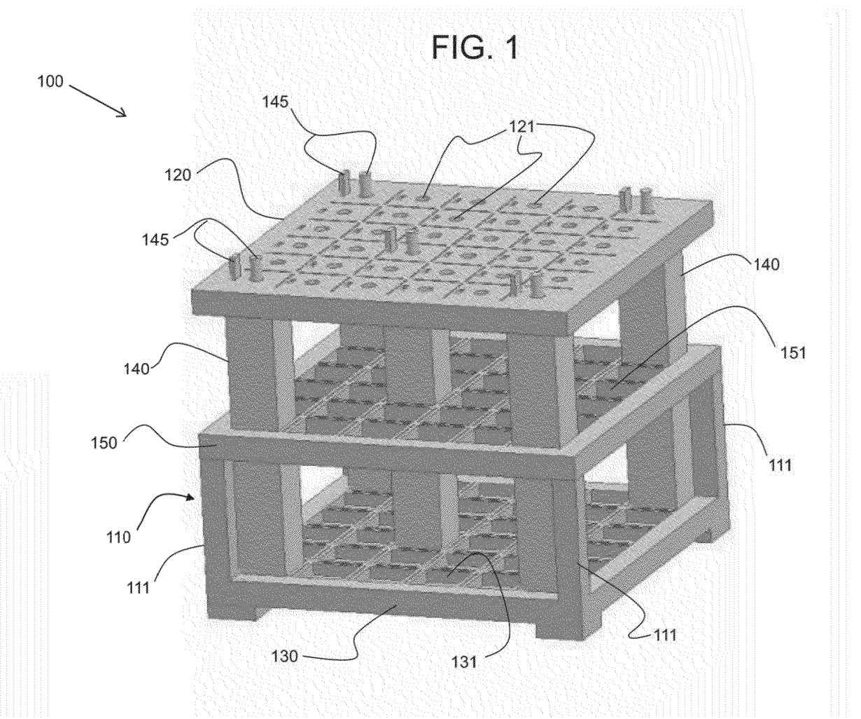

FIG. 1 is an illustration of a first embodiment of a cell alignment structure 100 for a multi-cell electrochemical device (e.g., a battery having multiple electrochemical cells for generating electricity). The cell alignment structure has a cell insertion section 110 and an upper stabilizing section 120. The cell insertion section 110 includes an array or grid 130 (base array) of electrically insulating cell receptacles 131. Each cell receptacle 131 is configured to receive and support a bottom portion of an electrochemical cell 140, for example, subsequent to the electrochemical cell being inserted into the receptacle. As shown in FIG. 1, the cells 140 and. the cell receptacles 131 are rectangular in shape, however, other geometries are possible as well in accordance with various embodiments.

Embodiments of such electrochemical cells can have dimensions of about 37 mm×27 mm×240 mm, any of which dimensions may vary by up to +/−50%, in accordance with various embodiments. In embodiments, the chemistry of a cell is of the sodium-metal-halide type, where NaCl and Ni are converted to Na and NiCl₇ during battery charging. The energy capacity of a cell can range from about 30 amp*hours to about 250 amps*hours.

An array of cells can be packaged into a housing to form a battery having typical dimensions of about 400 mm×500 mm×300 mm, any of which dimensions may vary by up to +/−50%, in accordance with various embodiments. In accordance with various embodiments, cooling channels are provided within the battery having a height ranging from about 2 mm to about 50 mm. Similarly, the width of a cooling channel can range from about 2 mm to about 50 mm. The operating temperature range of the cells can range between about 270° C. and about 350° C. in accordance with various embodiments.

The cell insertion section 110 also includes an array 150 (mid-region array) of electrically insulating cell guides 151 acting as a mid-cell stabilizing portion. Each cell guide 151 aligns with a corresponding cell receptacle 131, and each cell guide 151 is configured to mechanically stabilize a mid portion of an electrochemical cell 140 received in one of the receptacles 131. The base array 130 and the mid-region-array 150 each provide a determined spacing between inserted, adjacent electrochemical cells and are connected by vertical posts 111 at the four corners of the arrays. In accordance with certain embodiments, the resultant spacing of adjacent cells 140 within the cell alignment structure 100 is 1-4 millimeters, for example. Other spacings are possible as well, in accordance with other embodiments.

In embodiments, the outer cover of a cell is conductive and is at the established negative electrical potential of the cell (i.e., is effectively the negative terminal of the cell). By being electrically insulating, the cell alignment structure 100 eliminates the need for placing electrically insulating sheets of mica between rows of cells 140, or for plasma coating the cells, for example. Furthermore, the cell alignment structure 100 provides mechanical support and stability for the cells, reduces vibration of the cells during operation, establishes a defined cell-to-cell separation (which allows for use of multi-cell circuit connectors), relieves stress on cell-to-cell circuit connections, provides for better thermal equilibrium by sharing heat between cells, and allows for easier assembly/disassembly of the battery,

The upper stabilizing section 120 is electrically insulating and is configured to fit over a top portion of the plurality of electrochemical cells 140 held by the cell insertion section 110. The upper stabilizing section 120 is further configured to accept electrodes 145 of the plurality of electrochemical cells therethrough (e.g., through apertures or channels in the section 120). For example, as shown in FIG. 1, the electrodes 145 extend upward through apertures 121 in the upper stabilizing section 120. The upper stabilizing section 120 functions to further mechanically stabilize the electrochemical cells 140 within a battery and reduce vibration. In accordance with an embodiment, clamping bolts are provided between the cell insertion section 110 and the stabilizing section 120, providing more stability and reducing vibration. The clamping bolts may or may not be spring-loaded, in accordance with various embodiments.

In general, electrical connectors are provided to connect the electrodes 145 of the cells 140 in series, parallel, or some combination thereof. As an option, electrical connections can be embedded within the stabilizing section 120, providing the desired electrical connections between the electrodes 145 of the cells 140.

The cell alignment structure 100 can be an extruded structure (e.g., extruded aluminum that is coated with an electrically insulating material), an injection molded structure (e.g., silicone thermoset), a die-cast structure (e.g., diecast aluminum that is coated with an electrically insulating material), a folded structure (e.g., folded sheet metal that is coated with an electrically insulating material), a rolled structure, or a stamped structure, in accordance with various embodiments. Furthermore, the cell alignment structure 100 can be made of a plurality of stamped or formed parts which fit together or interlace together with or without attachments, or which are welded or glued together, for example, in accordance with various other embodiments.

Furthermore, the cell alignment structure 100 can be made of an anodized aluminum material, a silicone thermoset material, a porcelain-coated mild steel material, or some combination thereof, in accordance with various embodiments. Other materials are possible as well, in accordance with various other embodiments, as long as they provide an electrically insulating capability, either naturally or via an applied coating (e.g., an aluminum oxide coating) and can withstand the high temperatures (e.g., 350° C. or more) of the battery environment. In accordance with an embodiment, a first cell alignment structure may be configured to include complementary features (e.g., mating features), allowing a similar cell alignment structure to be stacked onto the first cell alignment structure.

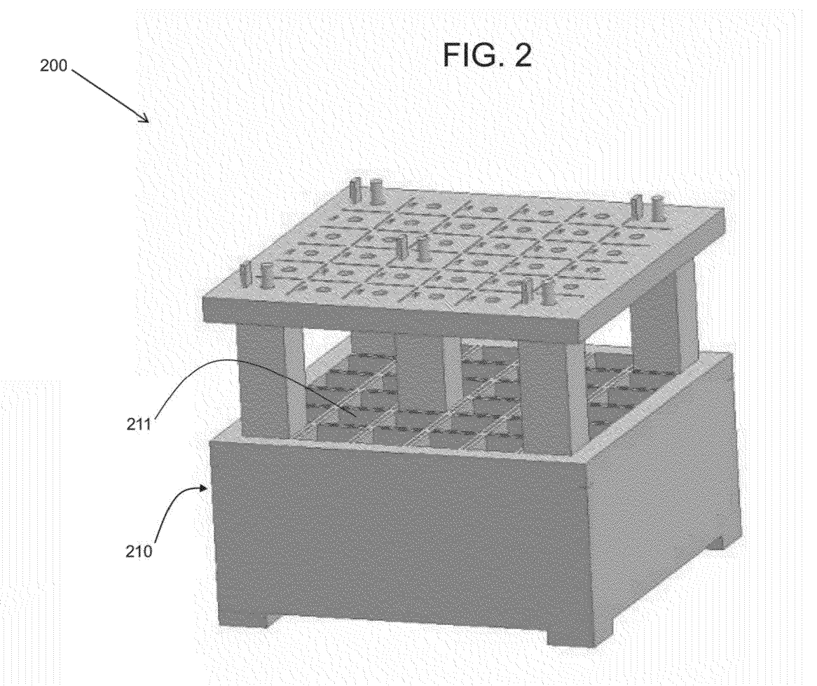

FIG. 2. is an illustration of an alternative embodiment of a cell alignment structure 200 for a multi-cell electrochemical device. The alternative embodiment is similar to the embodiment of FIG. 1 except that the arrays 130 and 150 are effectively incorporated, into one extended structure providing an extended array 210 of electrically insulating cell receptacles 211. Such an alternative embodiment can provide more stability of the cells 140 but can also use more material, however. In one embodiment, each cell receptacle of the extended. array 210 covers and supports at least 40% of the length of an electrochemical cell when the electrochemical cell is fully received in the receptacle. In another embodiment, each cell receptacle of the extended array 210 covers and supports at least 50% of the length of an electrochemical cell when the electrochemical cell is fully received in the receptacle. In another embodiment, the lower portion of the electrochemical cells received in the receptacles are fully covered, meaning there is no external exposure or access to the cells except through the tops of the receptacles.

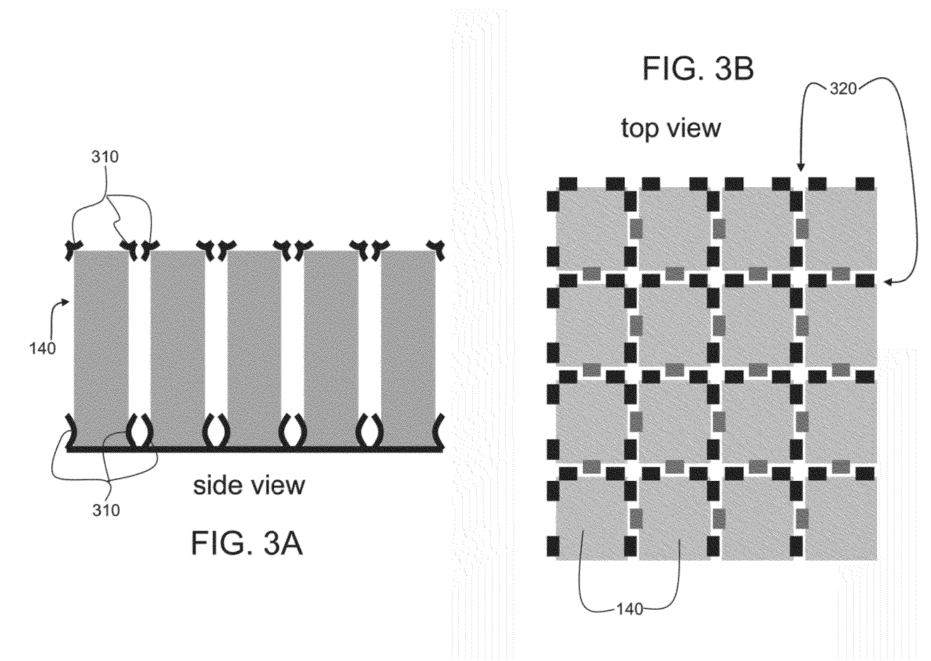

FIGS. 3A-3B illustrate embodiments of mechanical bias devices 310 (e.g., spring fingers or arms, leaf springs, coil springs, other types of bias devices) that can be integrated into the cell alignment structure 100 of FIG. 1, for example. The cell insertion section 110 includes a plurality of the bias devices 310 built into or otherwise attached to the base array 130 of cell receptacles 131 and/or the mid-region array 150 of electrically insulating cell guides 151. The bias devices 310 are configured to provide a holding tension between each cell receptacle 131 and an associated electrochemical cell 140 (e.g., spring-loaded pockets), and between each cell guide 151 and an associated electrochemical cell 140. Such bias devices 310 can compensate for variability in cell dimensions and/or cell receptacle dimensions, allowing for an acceptable hold to be maintained.

In accordance with an embodiment, the bias devices 310 are built-in on (or otherwise attached to) all four sides of a cell receptacle 131 and all four sides of the cell guide 151 in an interleaved (interlaced) configuration 320 of bias devices as shown in FIG. 3B. The interleaved configuration 320 reduces the amount of space required between adjacent cells 140 to accommodate the bias devices 310. That is, if the bias devices were directly across from each other, instead of being interleaved, more space between cells would be required to accommodate the bias devices. In addition, bias devices can also be built into the upper stabilizing section 120 in a similar manner to provide holding tension between upper portions of the cells 140. Referring again to FIG. 2, bias devices can be built into the extended array 210 at similar locations near the bottom portion and the top portion of the extended array 210).

As an alternative to bias devices, an adhesive can be used to adhere the cells 140 into the cell receptacles 131. However, with bias devices, a cell can be readily removed from a cell receptacle whereas, with an adhesive, a cell may not be readily removed. Furthermore, the adhesive has to be thermally stable, even at the high temperatures (e.g., 300° C.) at which a battery is operated. Some examples of high temperature adhesives include Armco Ceramabond 668, Aremco Ceramabond 671, Rutland Black, and Deacon Crow Seal 4022.

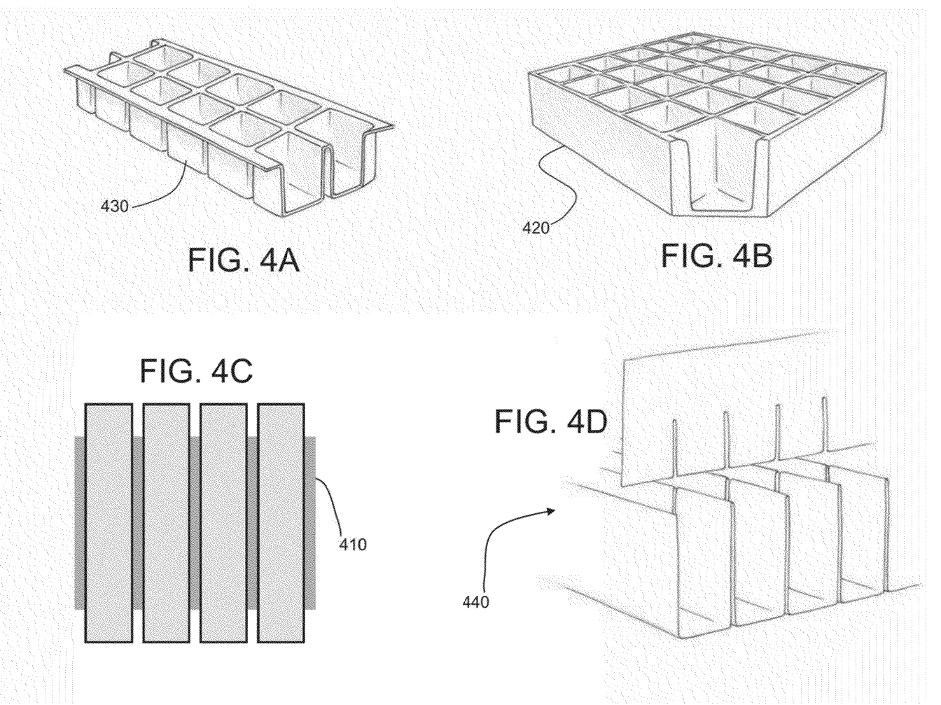

FIGS. 4A-4D illustrate several additional embodiments of cell alignment structures (cell trays) for a multi-cell electrochemical device. Again, the cell alignment structures can be extruded (e.g., see structure 410), injection molded or die-cast (e.g., see tray 420), folded (e.g., see tray 430), rolled, stamped, welded, or interlaced (e.g., see interlaced tray 140 with drop-in cross slats), in accordance with various embodiments. Furthermore, the cell alignment structures can be made of an anodized aluminum material, a silicone thermoset material, a porcelain-coated mild steel material, or some combination thereof, in accordance with various embodiments. Other materials are possible as well, in accordance with various other embodiments, as long as they provide an electrically insulating capability and can withstand the high temperatures of the battery environment.

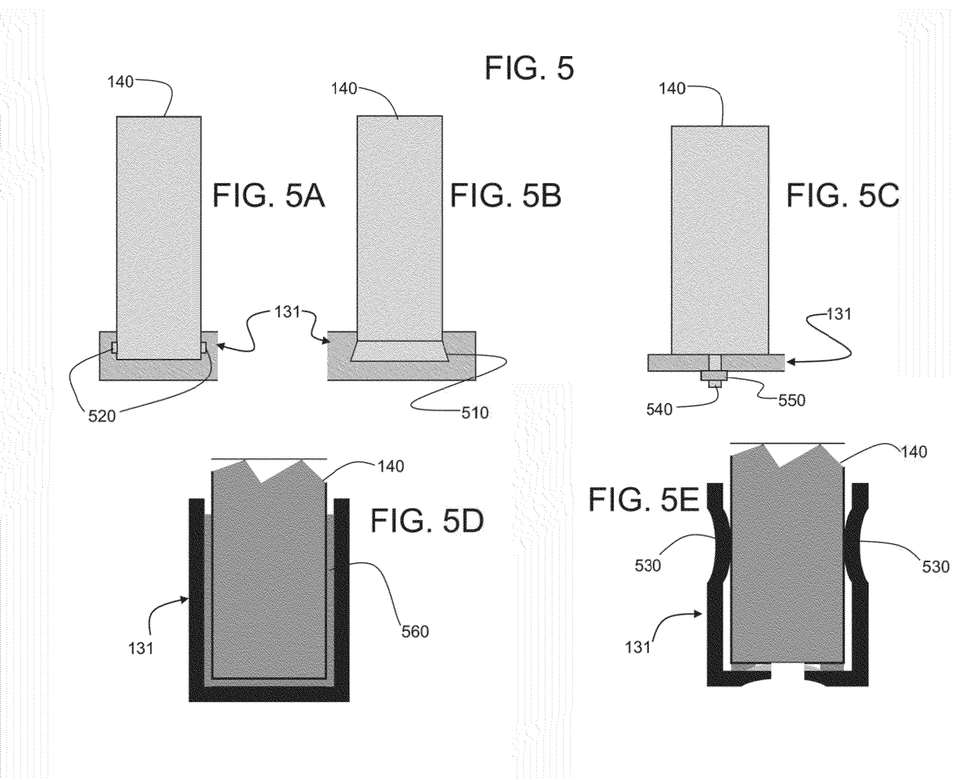

FIGS. 5A-5E illustrate several embodiments of cell receptacles 131 of a cell alignment structure mating with a bottom portion of an electrochemical cell 110. For example, the shape of an interior of a cell receptacle 131 can be formed to match (for mechanical mating purposes) the shape of a bottom portion of an inserted electrochemical cell 140 in a dove-tailed manner 510 or a snap-locking manner 520. Alternatively, a cell receptacle 131 can provide (or be provided with) pressure or tension elements 530 which press on the sides of an electrochemical cell 140 when inserted. For example, the tension elements can press into indentations on the sides of an electrochemical cell in accordance with an embodiment.

As another example, the bottom portion of a cell 140 can be configured with a bolt 540 and the cell receptacle 131 can include an aperture for the bolt 540 to penetrate therethrough. A locking nut 550 can be threaded onto the bolt 540 to mate the cell 140 to the cell receptacle 131. Furthermore, a cell receptacle can be lined with a flexible, adhering material 560 that effectively grips the cell 140 when the cell 140 is inserted into the cell receptacle 131. Other mating configurations are possible as well, in accordance with various embodiments.

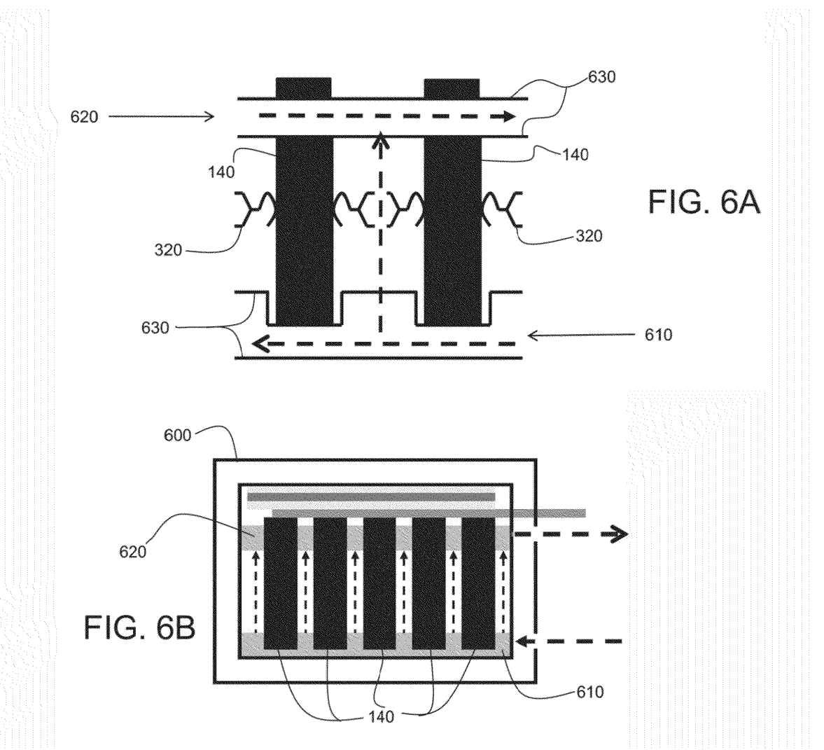

FIGS. 6A-6B illustrate an embodiment of a multi-cell battery 600 providing built-in cooling channels in the cell alignment structure. A cell alignment structure (whether injection molded, die-cast, etc.) can have cooling channels (e.g., air flow channels) and/or manifolds built-in. The cooling channels facilitate temperature stability of the battery. FIGS. 6A-6B show an inlet cooling channel 610 (which takes in a coolant near a bottom portion of the battery 600), and an outlet cooling channel 620 (which exhausts the coolant near a top portion of the battery 600), the battery 600 having a cell alignment structure 630. The cooling channels 610 and 620 can be hollow paths molded or cast, for example, into the cell alignment structure 630. Alternatively, the cooling channels 610 and 620 can be tubes fabricated into the cell alignment structure 630. Air or some other coolant gas (e.g., argon) or other coolant can be forced through the cooling channels to help dissipate thermal energy generated by the electrochemical cells during operation. The term “channel” refers to a structure that defines a pathway or passageway for the passage of air or other coolant.

The dashed arrows in FIGS. 6A-6B show the direction of airflow through the cell alignment structure. The cooling channels 610 and 620 allow air to flow along a lower portion of the cells 140 and along an upper portion of the cells 140 as shown by the dashed horizontal arrows in FIGS. 6A-6B. In accordance with an embodiment, air also flows from a lower portion of the cell alignment structure 630 to an upper portion of the cell alignment structure 630 between the cells 140 through vertically oriented gaps in the cell alignment structure 630 as shown in FIGS. 6A-6B by the dashed vertical arrows.

The vertically oriented gaps in the cell alignment structure 630 can be deliberately formed (e.g., via molding, casting, integrated cooling panels or tubes), in accordance with various embodiments. Alternatively, the gaps in the cell alignment structure 630 can simply be a residual artifact of the manufacturing process of the structure 630. For example, referring to FIGS. 3A-3B and FIGS. 6A-6B, the cell alignment structure can provide gaps formed by the spacing of the interlaced springs 320 of the cell alignment structure. As a further option, a dedicated (built-in or separate), vertically-oriented cooling channel can be provided running along the middle of a cell alignment structure.

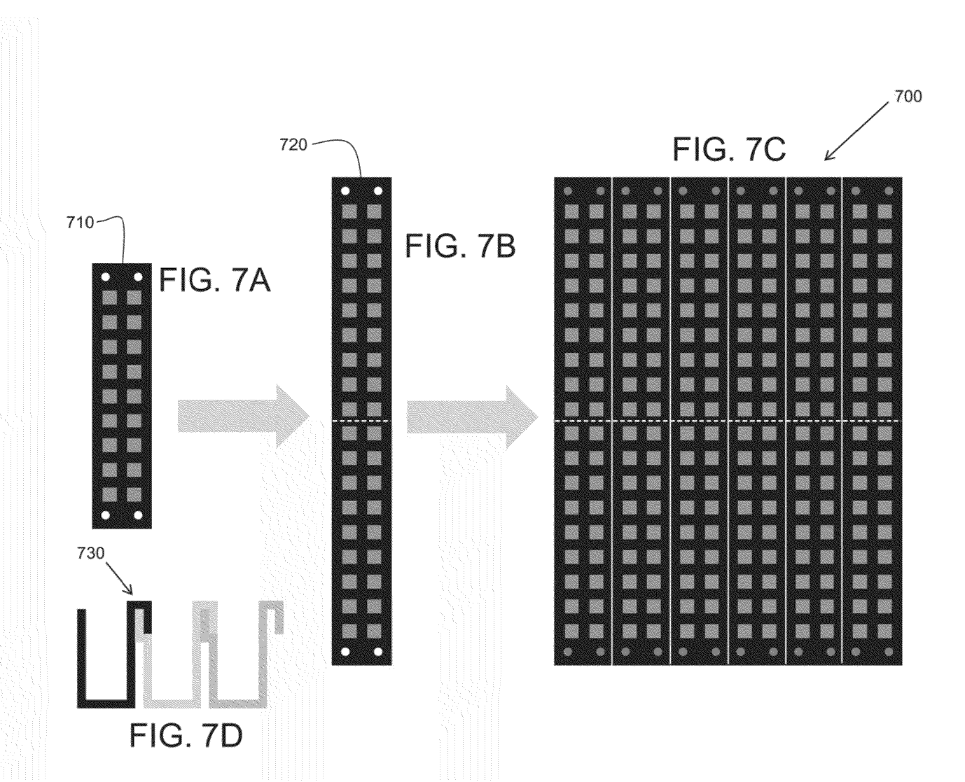

FIGS. 7A-7D illustrate an embodiment of a modular cell alignment structure 700 configured using a plurality of individual base cell alignment structures 710. The base cell alignment structure 710 is of the type discussed herein thus far and farther includes interconnecting portions 730 (see FIG. 7D) on the sides of the structure 710, allowing a plurality of similar structures 710 to be mechanically interconnected in a single plane to form a larger cell alignment structure. For example, referring to FIG. 7B, two base cell alignment structures 710 can he interconnected on their narrow sides to form an interconnected cell alignment structure 720. Furthermore, referring to FIG. 7C, six interconnected cell alignment structures 720 can be interconnected on their long sides to form the modular cell alignment structure 700.

In accordance with an embodiment, the interconnecting portions 730 snap and lock together as shown in FIG. 7D. Forming a modular cell alignment structure from a plurality of smaller base cell alignment structures provides for better manufacturability scalability, and serviceability of cell alignment structures. In accordance with certain alternative embodiments, the interconnecting portions of the plurality of base cell alignment structures 710 are configured to be bolted together or heat welded together. Other interconnecting configurations are possible as well. As a further alternative, the interconnecting portions 730 are not provided and each base cell alignment structure is simply mounted (e.g., bolted) to an inner battery box in relation to each other to form the larger cell alignment structure.

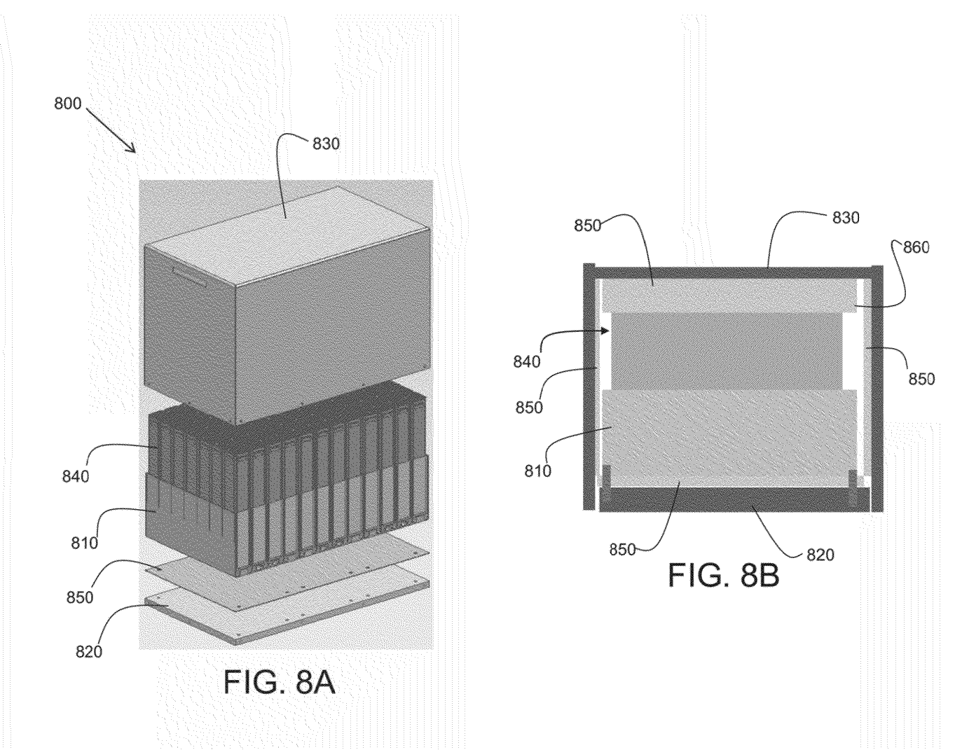

FIGS. 8A-8B illustrate an embodiment of an inner battery packaging assembly 800 of an electrochemical device. The assembly 800 includes a cell alignment structure 810 (e.g., of a type discussed herein), a base 820 (e.g., a base plate) configured to be disposed below the cell alignment structure 810, and an inner cover 830 configured to fit over (e.g., drop down over) the cell alignment structure 810 and removably attach to the base plate 820. The assembly 800 also includes a plurality of removable insulating sheets 850 (e.g., mica sheets) configured to be disposed adjacent to interior surfaces of the base plate 820 and the cover 830 to surround a plurality of electrochemical cells 840 inserted into the cell alignment structure 810. The assembly 800 further includes a heater 860. In accordance with an embodiment, the cell alignment structure 810 is a modular cell alignment structure made up of two or more horizontally interconnected arrays of electrically insulating cell receptacles, as discussed herein with respect to FIGS. 7A-7D. When the inner battery packaging assembly is assembled as part of an electrochemical device, in an embodiment, the electrochemical device includes: a base plate; a cell alignment structure above the base plate; optionally, a bottom insulating sheet disposed between the base plate and the cell alignment structure; a plurality of electrochemical cells received in the receptacles of the cell alignment structure (the cells are electrically interconnected in series and/or parallel); a cover that fits over the cell alignment structure and electrochemical cells, which is attached to the base plate; and optionally, for side insulating sheets and a top insulating sheet disposed between the cover and the cell alignment structure and the cells. In another embodiment, the electrochemical device further includes a heater positioned over the top of the electrochemical cells. In other embodiments, the electrochemical device further includes one or more of the features of FIGS. 1-7D, such as a mid-cell stabilizing portion 150, 151. Although FIGS. 7A-7D show a five-sided cover and base plate, in other embodiments, the base is a live-sided box (into which the cell alignment structure and the cells are received), and the cover is a plate that fits over and attaches to the box. In embodiments, one or both of the base and the cover include peripheral edge flanges for facilitating attachment of the base to the cover.

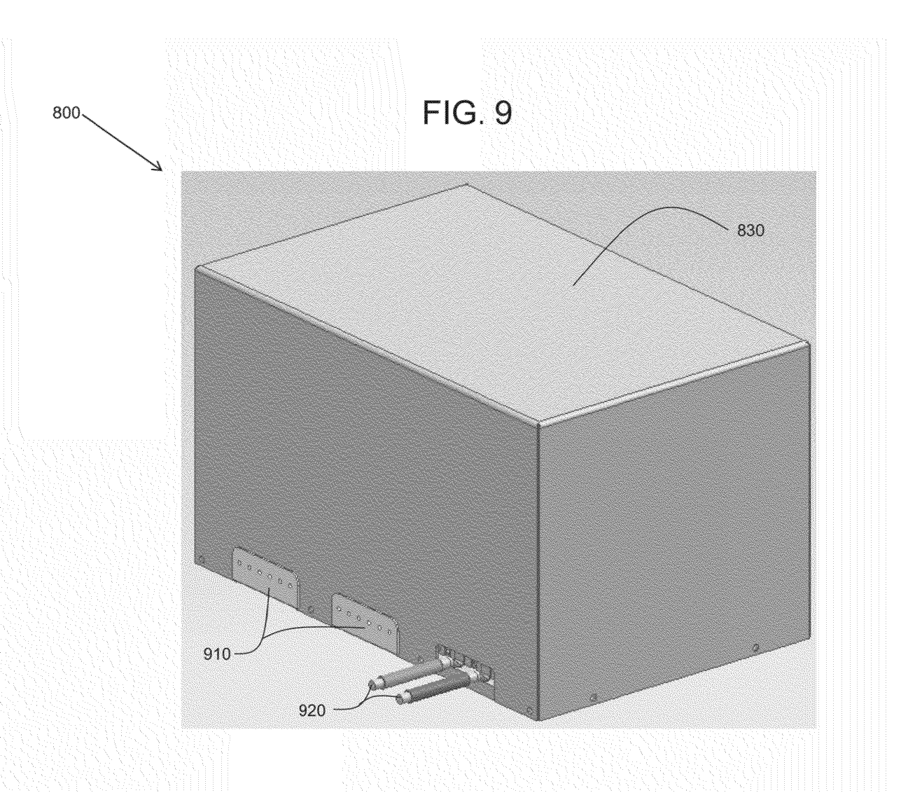

FIG. 9 is an illustration of an embodiment of the inner battery packaging assembly 800 of FIGS. 8A-8B having ceramic feed-through blocks 910. The ceramic feed-through blocks 910 are configured to limit heat loss from within the assembly 800 during operation where electrical interfaces (e.g., communication wires, temperature probe wires, heater wires), cooling air ducts, and bus bar leads are fed through FIG. 9 shows a pair of bus bar leads 920 coming out of the assembly 800, where a ceramic feed-through block 910 is removed. When fully assembled, the assembly 800 includes a ceramic feed-through block 910 to limit heat loss from within the assembly 800 where the bus bar leads 920 exit the assembly 800.

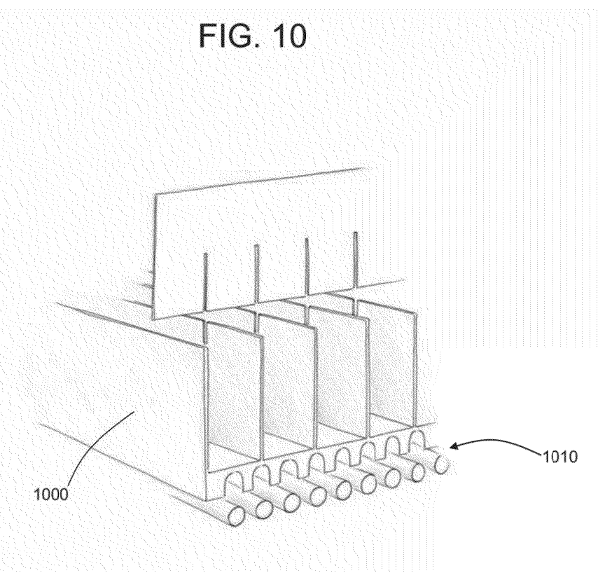

FIG. 10 illustrates an embodiment of a portion of a cooling channel 1010 disposed below an exploded view of a portion of a cell alignment structure 1000 of an inner battery packaging assembly. The cell alignment structure 1000 is of the interlaced type as discussed above herein with respect to FIG. 4D. The cell alignment structure 1000 does not have a built-in cooling channel but, instead, has a cooling channel 1010 disposed below the cell alignment structure 1000 in the form of a plurality of tubes for channeling air or some other type of gas or liquid fluid, for example. In accordance with an embodiment, a base plate 820 (as shown in FIGS. 8A-8B) is disposed beneath the cooling channel 1010 as part of an inner battery packaging assembly. An insulating sheet 850 can be disposed between the cooling channel 1010 and the base plate 820, in accordance with certain embodiments.

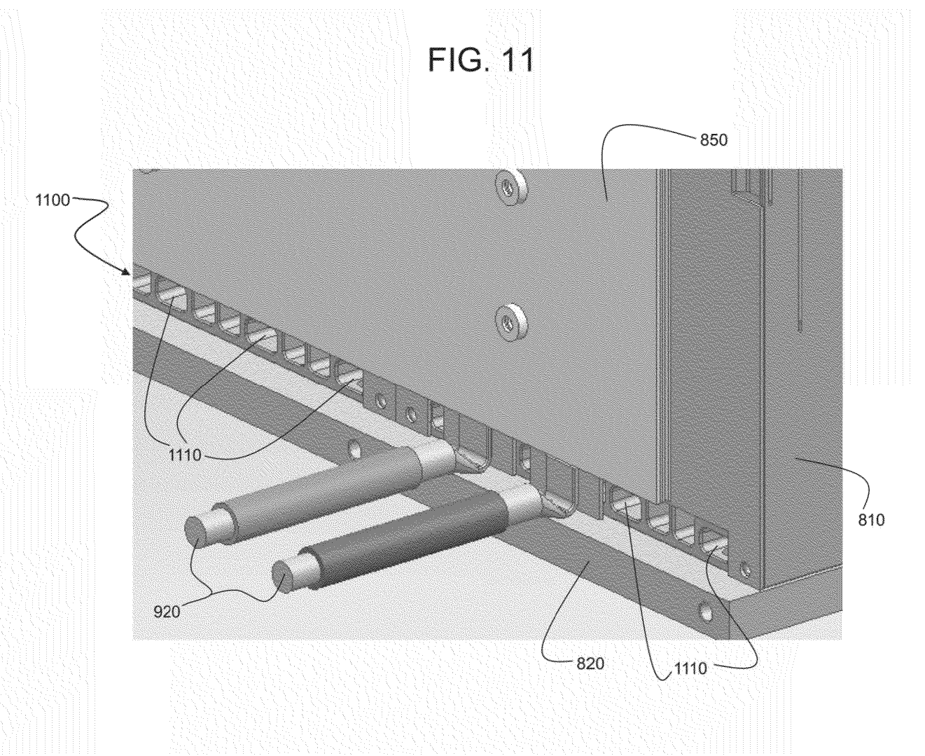

FIG. 11 is an illustration of an embodiment of a lower portion of the inner battery packaging assembly 800 of FIGS. 8A-8B and FIG. 9 having the cover 830 removed to show a cooling channel 1100 disposed below the cell alignment structure 810 and above the base plate 820. In FIG. 11, the cooling channel 1100 provides a plurality of parallel pathways 1110 that run above the base plate 820 and under the cell alignment structure 810. Air or some other gas (e.g., argon) or other coolant can be forced through the parallel pathways 1110 of the cooling channel 1100 to help dissipate thermal energy generated by the electrochemical cells 840 during operation. Again, as an alternative, a cooling channel can be built into the cell alignment structure 810.

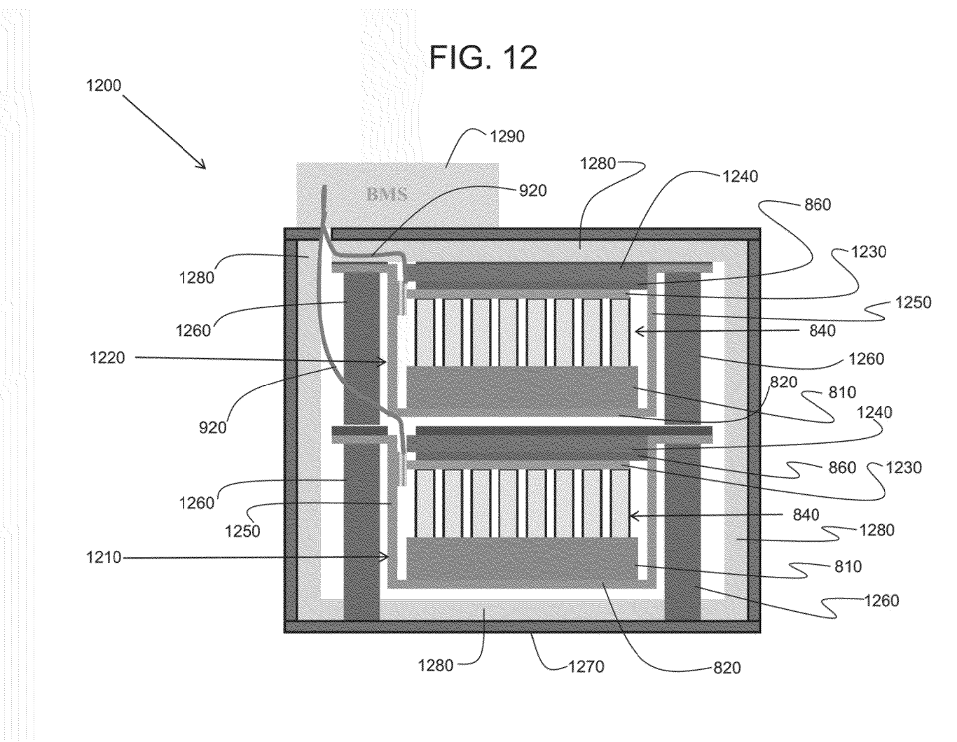

FIG. 12 is an illustration of an embodiment of a stacked configuration 1200 of two inner battery packaging assemblies within a larger (outer) battery packaging assembly (i.e., a battery). Such a stacked configuration may be used in a fork lift or mining vehicle application, for example, where additional electrical power is demanded than can be provided by a single inner battery packaging assembly. Each inner battery packaging assembly 1210 and 1220 of FIG. 12 is similar to the inner battery packaging assembly 800 of FIGS. 8A-8B in that each has a cell alignment structure 810, a base 820 (e.g., a base plate), a plurality of electrochemical cells 840 received in the cell alignment structure 810, and a heater 860. FIG. 12 also illustrates electrical interconnects 1230 which electrically connect the electrodes of the cells 840.

Each inner battery packaging assembly 1210 and 1220 includes a thermally insulating aerogel material 1240 above the heater 860, although other high temperature thermal insulators may be substituted. Furthermore, each inner battery packaging assembly 1210 and 1220 includes an inner box support frame 1250 configured to support the cells 840 in the cell alignment structure 810 on the base plate 820, and configured to mount to a stacking support frame 1260. The inner battery packaging assembly 1220 is mounted to the stacking support frame 1260 above the inner battery packaging assembly 1210 which is also mounted to the stacking support frame 1260. In accordance with an alternative embodiment, the inner box support frame 1250 of each of the inner battery packaging assemblies 1210 and 1220 includes complementary features (e.g., mating features), allowing the support frame 1250 of one assembly 1210 to mount to the support flame 1250 of the other assembly 1220. Such an alternative embodiment may allow the elimination of the stacking support frame 1260.

The entire stacked configuration 1200 is enclosed in an external enclosure 1270, and a high temperature, thermally insulating material (e.g., vacuum insulated panels, or aerogel) 1280 surrounds the interior sides of the external enclosure 1270 to thermally insulate the entire stacked configuration 1200. The bus bars 920 from each of the inner battery packaging assemblies 1210 and 1220 are routed out of the stacked configuration 1200 to a battery management system (BMS) 1290, in accordance with an embodiment. Alternatively, two BMS's can be provided, one for each inner battery packaging assembly.

The stacked configuration 1200 provides a modular configuration of inner battery packaging assemblies that can be easily assembled and serviced. Stacked configurations of three or more inner battery packaging assemblies are possible as well, in accordance with various other embodiments. Such dense vertical stacking reduces the outer surface area, minimizes the footprint, requires less insulation, and is more thermally efficient than having two separate, unstacked configurations, for example.

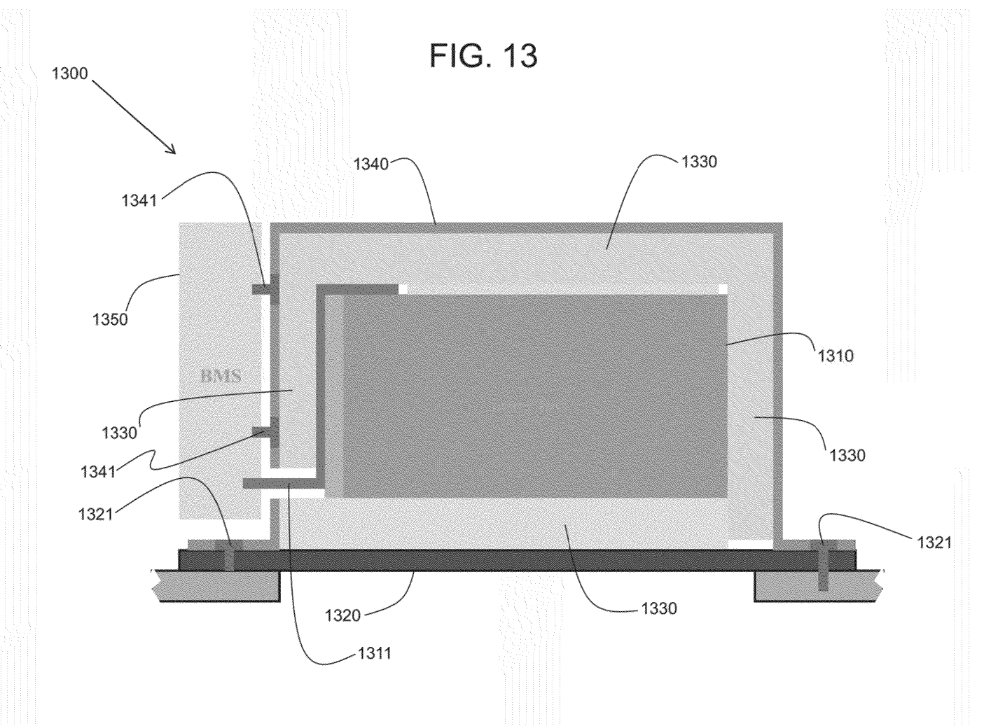

FIG. 13 is an illustration of an embodiment of an outer battery packaging assembly 1300 for an electrochemical device that is a non-vacuum configuration. The term “non-vacuum” is used herein to refer to a configuration where a vacuum is not actively “pulled” between an inner battery box and an outer housing of the battery 1300. In prior art configurations where a vacuum is pulled to thermally insulate the outer battery box from the hot inner battery box, the inner battery box is typically welded within the outer battery box to form a tight seal. In order to service such a sealed configuration, the outer battery box may have to be cut open (e.g., with a cutting torch) to get at the inner battery box.

The assembly 1300 includes an inner battery packaging assembly 1310 (e.g., similar to the inner battery packaging assembly 800 of FIGS. 8A-8B and FIG. 9), an outer support plate 1320 disposed below the inner battery packaging assembly 1310, and removable thermal insulating material 1330 surrounding the inner battery packaging assembly 1310 which gets hot during operation. In accordance with an embodiment, the thermal insulating material 1330 can be vacuum insulated panels, aerogel (e.g., Pyrogel 6650), fumed silica (e.g., Btu-Board), furnace insulation, or some combination thereof. Other high temperature, thermally insulating materials are possible as well, in accordance with various embodiments.

The assembly 1300 also includes a removable outer battery cover 1340 configured to drop down and fit over the inner battery packaging assembly 1310, and over the surrounding thermal insulating material 1330, and removably attach to the outer support plate 1320 (e.g., via bolts 1321). In accordance with an embodiment, the battery cover 1340 is made of stainless steel, although other materials are possible as well. The removable cover allows service personnel to more readily access the insulating material and the inner battery packaging assembly.

The assembly 1300 further includes a battery management system (BMS) 1350 configured to be mounted to the outer battery cover 1340 (e.g., via bolts 1341) and to operatively interface with components disposed within the inner battery packaging assembly 1310 (e.g., via bus bar leads 1311, control signal electrical leads, monitored parameter electrical leads, voltage sensing wires, heater leads, etc., which are routed through the insulating material 1330). The bus bar leads 1311 can be insulated solid metal leads (e.g., flat or round), or insulated cables that are stranded and flexible, in accordance with certain embodiments.

In accordance with an embodiment, certain leads and wires can be routed through a cooling channel of the battery packaging assembly 1300 (e.g., a cooling channel of the inner battery packaging assembly 1310) to provide access for measurement of internal parameters of the packaging assembly. For example, a resistive thermal device (RID) or thermocouple can be located, within the inner battery packaging assembly 1310 for the purpose of measuring temperature. Wires from the RTD can be routed through a cooling channel and out to the BMS 1350. In accordance with an alternative embodiment, a dedicated channel that is not used for cooling can be configured within the battery packaging assembly 1300 to provide access for measurement of internal parameters. The BMS 1350 is the controller of the battery and serves to control temperature of the battery and the charging and discharging of the battery.

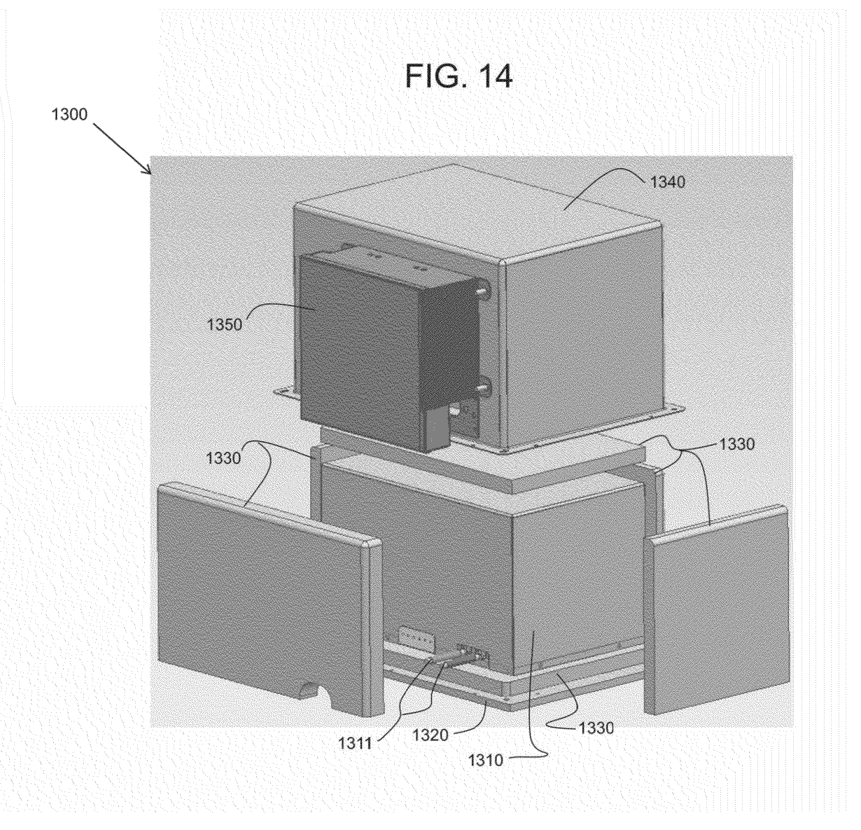

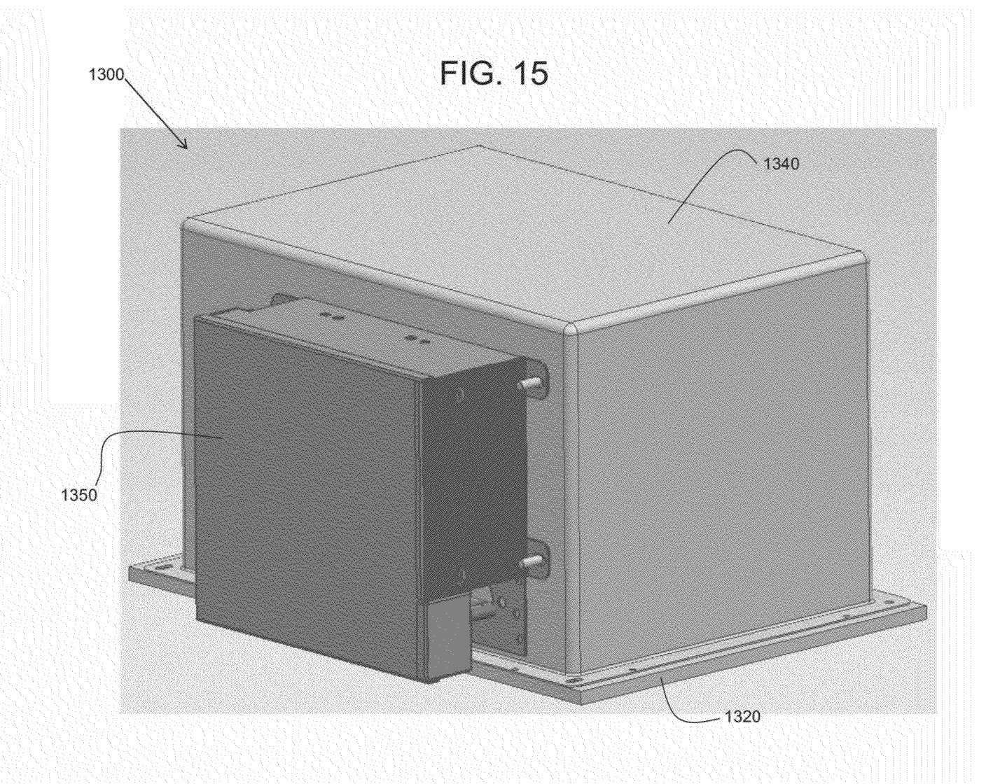

FIG. 14 is an exploded view of an embodiment of the battery packaging assembly 1300 of FIG. 13. The exploded view shows the inner battery packaging assembly 1310, the removable thermally insulating material 1330 in the form of six vacuum insulated, panels, the outer support plate 1320, and the outer battery cover 1340 with the attached BMS 1350. The removable outer battery cover 1340 and the removable thermal insulating material 1330 improve the ability to manufacture and service the assembly 1300, and make the inner battery packaging assembly 1310 easily accessible. FIG. 15 is an illustration of a fully assembled view of an embodiment of the battery packaging assembly 1300 of FIG. 13 and FIG. 14.

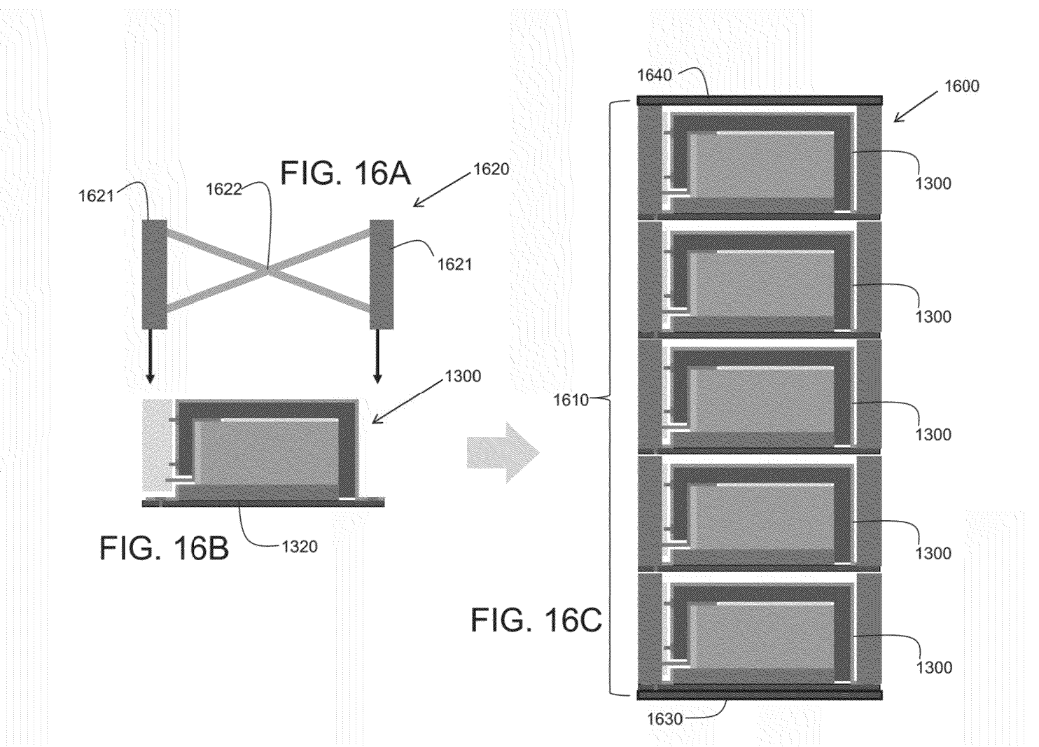

FIGS. 16A-16C illustrate an embodiment of a stacked configuration 1600 of several of the outer battery packaging assemblies 1300 of FIG. 13 within a rack assembly 1610. Such a stacked configuration may be used in a fork lift or mining vehicle application, for example, where additional electrical power is demanded than can be provided by a single battery packaging assembly. The rack assembly 1610 includes a sub-assembly 1620, for each assembly 1300, which includes four corner posts 1621 and cross-bracings 1622 that mount between the support plates 1320 of the assemblies 1300, for example, via bolts. That is, the support plates 1320 of the batteries function as rack shelves.

The stacked configuration 1600 includes five outer battery packaging assemblies 1300 vertically stacked using the rack assembly 1610. A bottom rack support plate 1630 serves to support the entire assembly 1600 and is bolted to the lowest sub-assembly 1620 through the lowest support plate 1320, in accordance with an embodiment. A top rack plate 1640 can be mounted to the upper-most sub-assembly 1620 at the top of the assembly 1600 for providing added stability and protection from above.

The stacked configuration 1600 provides a modular configuration of batteries that can be easily modified (i.e., batteries can be added or taken away) as application requirements change. Furthermore, the stacked configuration 1600 minimizes the footprint of the multiple packaging assemblies 1300. In accordance with an alternative embodiment, the outer packaging assembly is configured to have complementary features (e.g., mating features) allowing the outer packaging assembly to be vertically stacked within a rack with other similar battery packaging assemblies.

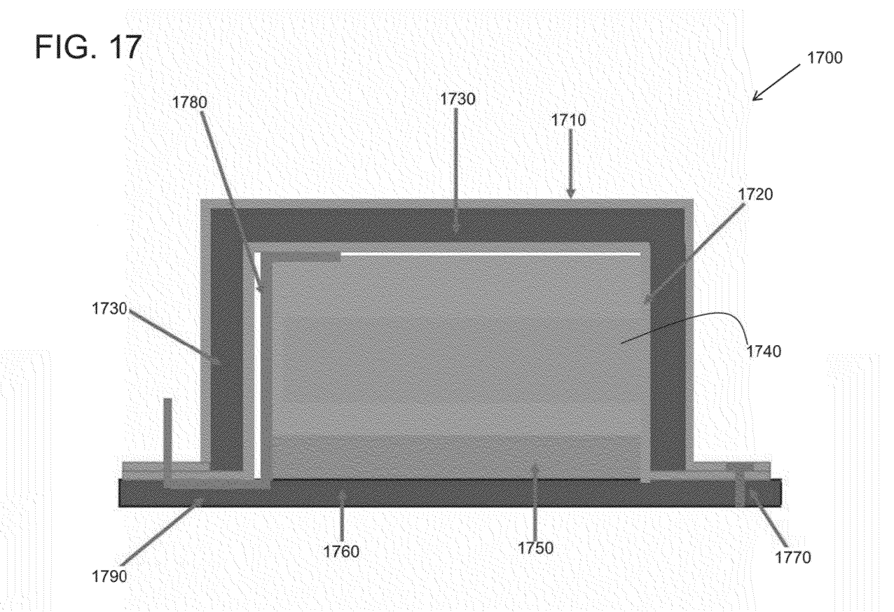

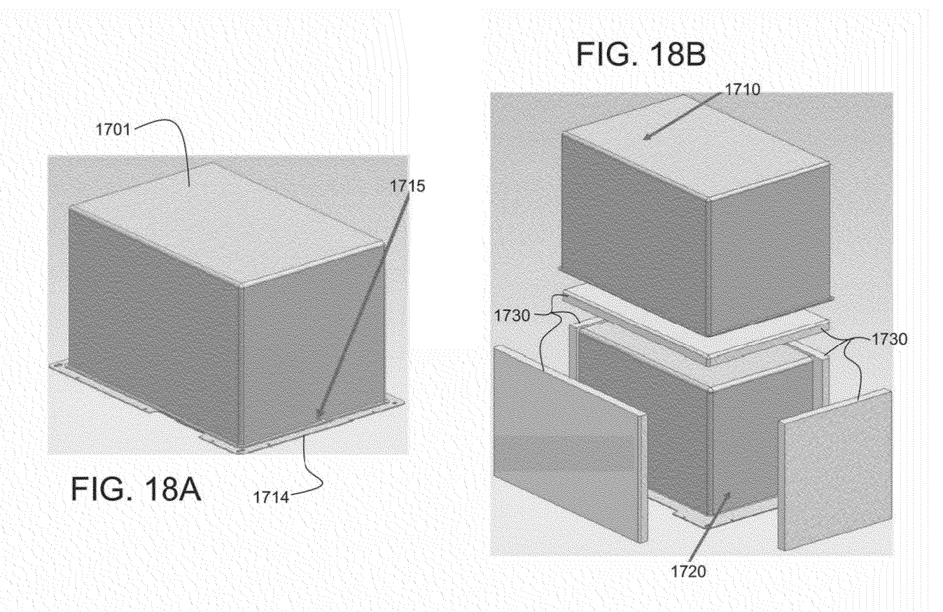

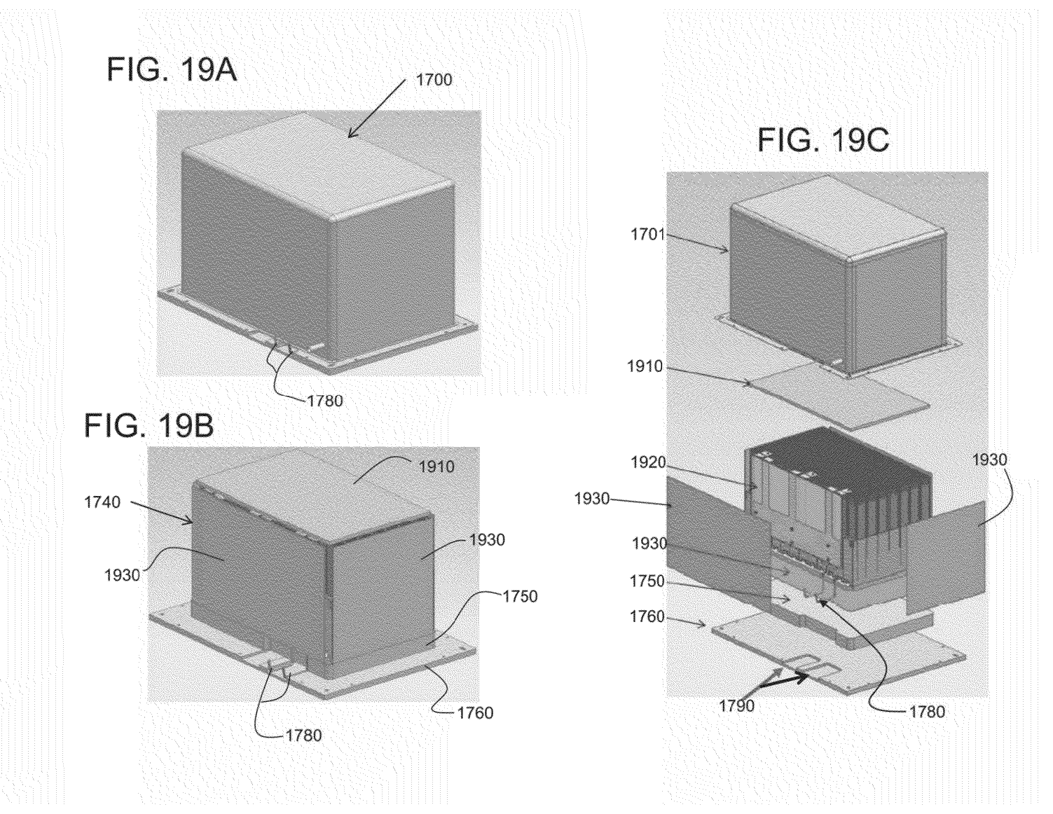

In accordance with an alternative embodiment, a battery configuration 1700 includes an outer battery cover 1710 and an inner battery cover 1720 that are integrated into a single cover with a thermal insulating material 1730 vacuum insulated panels) therebetween, as shown in FIGS. 17-19C, to form a vacuum lid “top hat” configuration 1701 (i.e., an insulated cover). The outer battery cover 1710 is nested over the inner battery cover 1720, and the outer battery cover 1710 is welded to a base portion 1714 of the inner battery cover 1720 along a perimeter portion 1715 of the outer battery cover 1710 forming a sealed space therebetween, in accordance with an embodiment. The thermal insulating material 1730 occupies the sealed space between the inner battery cover 1720 and the outer battery cover 1710. In accordance with an embodiment, the thermal insulating material 1730 includes five vacuum insulated panels as shown in FIG. 18B.

The integrated cover 1701 fits over an inner battery assembly 1740 having a battery tray assembly 1920 of electrochemical cells, mica sheets 1930, a heater 1910, etc. The inner battery assembly 1740 rests on a bottom thermal insulation layer 1750 above a bottom support plate 1760. In accordance with an embodiment, the integrated cover 1701 is bolted to the bottom support plate 1760 via perimeter bolts 1770, and the wiring 1780 (e.g., bus bar cables, heater leads, and the like) is routed out of the inner battery assembly 1740 through cut-outs 1790 in the bottom support plate 1760.

In any of the embodiments herein where elements are perpendicular, such elements may be generally perpendicular, meaning 90 degrees plus or minus 3 degrees, to account for relatively minor manufacturing variances/tolerances. Similarly, in any of the embodiments herein where elements are parallel, such elements may be generally parallel, meaning 0 degrees plus or minus 3 degrees, to account for relatively minor manufacturing variances/tolerances.

In the appended claims, the terms “including” and “having” are used as the plain language equivalents of the term “comprising”; the term “in which” is equivalent to “wherein.” Moreover, in the following claims, the terms “first,” “second,” “third,” “upper,” “lower,” “bottom,” “top,” etc, are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. Moreover, certain embodiments may be shown as having like or similar elements, however, this is merely for illustration purposes, and such embodiments need not necessarily have the same elements unless specified in the claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differentiate from the literal language of the claims, or if they include equivalent structural elements with insubstantial differences from the literal language of the claims.

What is claimed is:

1. A cell alignment structure for an electrochemical device, comprising:
an array of electrically insulating cell receptacles, each cell receptacle configured to receive and support at least a bottom portion of an electrochemical cell,
wherein said array of cell receptacles is configured to provide a determined spacing between adjacent electrochemical cells received in the cell receptacles.

2. The structure according to claim 1, further comprising a stabilizing section configured to fit over respective electrode portions of a plurality of electrochemical cells received in the cell receptacles,
wherein the stabilizing section is configured to accept the electrode portions of the plurality of electrochemical cells therethrough.

3. The structure according to claim 1, further comprising a plurality of interleaved mechanical We devices attached to the array of cell receptacles and configured to provide a holding tension between each cell receptacle and an associated electrochemical cell.

4. The structure according to claim 1, wherein the array of cell receptacles is at least one of an extruded structure, an injection molded structure, a die-cast structure, a folded structure, a rolled structure, a stamped structure, a welded structure, or an interlaced structure.

5. The structure according to claim 1, wherein the array of cell receptacles is made of at least one of an anodized aluminum material, a silicone thermoset material, or a porcelain-coated mild steel material.

6. The structure according to claim 1, wherein each of the cell receptacles is configured to mate with a bottom portion of an inserted electrochemical cell.

7. The structure according to claim 1, wherein the array of cell receptacles is configured to interconnect with at least one other similar array of cell receptacles to form a larger array of cell receptacles.

8. The structure according to claim 1, wherein the cell alignment structure is configured to have complementary features allowing the cell alignment structure to be stacked in relation to a similar cell alignment structure.

9. The structure according to claim 1, wherein the array of cell receptacles includes at least one built-in cooling channel.

10. An inner battery packaging assembly for an electrochemical device, comprising:
the cell alignment structure of claim 1;
a base plate configured to be disposed below the cell alignment structure; and
a cover configured to fit over the cell alignment structure and removably attach to the base plate.

11. The packaging assembly according to claim 10, further comprising one or more removable insulating sheets configured to be disposed adjacent to interior surfaces of one or more of the base plate or cover.

12. The packaging assembly according to claim 10, wherein the cover includes at least one ceramic feed-through block configured to limit heat loss from within the packaging assembly during operation where at least one of electrical interfaces, cooling air ducts, or bus bar leads are fed through the block.

13. The packaging assembly according to claim 10, further comprising at least one cooling channel disposed below the cell alignment structure and above the base plate.

14. The packaging assembly according to claim 10, wherein the cell alignment structure includes at least one built-in cooling channel.

15. The packaging assembly according to claim 10, wherein the cell alignment structure includes at least two horizontally interconnected arrays of electrically insulating cell receptacles.

16. The packaging assembly according to claim 10, wherein the inner battery packaging assembly is configured to have complementary features to allow vertical stacking with other similar inner battery packaging assemblies.

17. An outer battery packaging assembly for an electrochemical device, comprising:
the inner battery packaging assembly of claim 10;
an outer support plate configured to be disposed below the inner battery packaging assembly;
thermal insulating material removably surrounding at least a portion of the inner battery packaging assembly; and
an outer battery cover configured to fit over the inner battery packaging assembly, and over the thermal insulating material, and removably attach to the outer support plate.

18. The outer battery packaging assembly according to claim 17, farther comprising a battery management system configured to be mounted to the outer battery cover and to operatively interface with components disposed within the inner battery packaging assembly for control of temperature of the inner battery packaging assembly and the charging and discharging of electrochemical cells of the inner battery packaging assembly.

19. The outer battery packaging assembly according to claim 17, wherein the thermal insulating material includes at least one of vacuum insulated panels, aerogel, fumed silica, and furnace insulation.

20. The outer battery packaging assembly according to claim 17, wherein the outer packaging assembly is configured to have complementary features allowing the outer packaging assembly to be vertically stacked within a rack with other similar battery packaging assemblies.

21. The outer battery packaging assembly according to claim 17, further comprising at least one channel within the outer battery packaging assembly providing access for measurement of at least one internal parameter of the outer battery packaging assembly.

22. An insulated cover for an electrochemical device, comprising:
an inner battery cover configured to fit over an inner battery assembly;
an outer battery cover nested over the inner battery cover, wherein the outer battery cover is attached to a base portion of the inner battery cover along a perimeter portion of the outer battery cover forming a sealed space therebetween; and
a thermal insulating material occupying at least a portion of the scaled space.

23. The insulated cover according to claim 22, wherein the thermal insulating material comprises a plurality of vacuum insulated panels.

24. An electrochemical device, comprising:
an array of electrically insulating cell receptacles;
a plurality of electrochemical cells, the cells having bodies and top and bottom portions at distal ends of the bodies, wherein the bottom portion of the cells are respectively received in and supported by the cell receptacles;
a stabilizing section engaging the top portions of the cells;
a base plate positioned under the array of electrically insulating cell receptacles; and
a cover positioned over the stabilizing section and removably attached to the base plate.
